(19) United States
(12) Patent Application Publication
(10) Pub. No.: US 2003/0218675 A1
(43) Pub. Date: Nov. 27, 2003

(54) Video picture processing method

(75) Inventor: Yasumasa Nonoyama, Tokyo (JP)

Correspondence Address: LEYDIG VOIT & MAYER, LTD, 700 THIRTEENTH ST. NW, SUITE 300, WASHINGTON, DC, 20005-3960, US

(73) Assignee: Mitsubishi Denki Kabushiki Kaisha, Tokyo (JP)

(21) Appl. No.: 10/365,689

(22) Filed: Feb. 13, 2003

(30) Foreign Application Priority Data
Feb. 25, 2002 (JP) P2002-048595

(51) Int. Cl. H04N 7/18; H04N 9/47

(52) U.S. Cl. 348/144; 348/140

(57) ABSTRACT

In carrying out an operation of taking video pictures of a ground surface flying in the air and transmitting the video pictures to any other ground to recognize situation existing on the ground surface, there is a difficulty in accurately determining a shot location on a map. The invention provides a video picture processing method intending to take a shot of a ground surface from a video camera mounted on an airframe in the air and identify situations existing on the ground surface. In this method, a photographic position in the air is specified three-dimensionally, a photographic range of the ground surface having been shot is computed, and a video picture is transformed in conformity with the photographic range. Thereafter, the transformed picture is displayed in such a manner as being superimposed on a map of a geographic information system.

### BACKGROUNED OF THE INVENTION

1. Field of the Invention

The present invention relates to a video picture processing method in which a video picture, which is transmitted from a video camera mounted onto a helicopter, for example, is displayed in such a manner as being superimposed on (a map of a geographic information system, thereby enabling to determine situations on the ground such as earthquake disaster easily as well as accurately.

2. Description of the Related Art

Description Of Constitution Of the Prior Art

FIG. 14 is a schematic view showing a principal constitution of the conventional apparatus disclosed in the Japanese Patent Gazette No. 2695393. A video camera 2 such as television camera is mounted onto a body of a helicopter 1 flying in the air, and shoots a picture of a target object 3. The object 3 exists on a ground surface 4 having three-dimensional ups and downs, and not on a two-dimensional plane 5, which is obtained by casting a reflection of the ground surface 4 onto a horizontal plane. In this example shown in FIG. 14, a current position of the helicopter 1 is measured, and a position of the object 3 is specified as an intersection between a straight line L extending from the current position of the helicopter 1 in the direction of the object position and the ground surface 4. Since the ground surface 4 exists at a level different from the two-dimensional plane 5 just by a height H, a position of the intersection of the straight line up to the object 3 extending and intersecting with the two-dimensional plane 5 is determined to be different from the position of casting a reflection of the object 3 onto the two-dimensional plane 5 just by a distance E. Accordingly, in this prior art, position of the object 3 can be accurately specified on the ground surface 4.

In FIG. 16, a process of finding out a disaster occurrence point from an aerial video picture 6 of FIG. 15 is shown. Supposing that a screen corresponding to a disaster occurrence point 20 shown in FIG. 16 (1) is enlarged and displayed as shown in FIG. 16 (2), situations of damage can be known in detail. The disaster occurrence point 20 is specified based on three-dimensional position information including azimuth PAN and a tilt angle TILT of the camera mounted on board, and altitude information of the helicopter 1.

FIG. 17 shows a state in which the specified disaster occurrence point 20 is image-displayed in conformity with the two-dimensional map. A region corresponding to a camera-viewing field 21 conducting an image display is indicated at a circumferential part of the disaster occurrence point 20. Further, the arrow indicates a camera direction 22. Although specifying the disaster occurrence point 20 is accompanied with a certain degree of error owing to various factors, by watching the aerial video picture 6 taking into, consideration the camera viewing field 21 and the camera direction 22, it is possible to more accurately specify the disaster occurrence point 20.

FIG. 18 shows a schematic constitution of devices relevant to position specification, and the devices are mounted onto the helicopter 1 of FIG. 14. The video camera 2 includes a camera 30 and a gimbal unit 31. The camera 30 includes a TV camera 30a and an infrared camera 30b, thereby enabling to obtain an aerial video picture any time day or night. The camera 30 is attached to the gimbal unit 31 containing two or three axis-stabilizing gyro, and shoots a picture of outside the helicopter 1 of FIG. 14.

An video picture signal shot by the video camera 2 and direction of the gimbal unit 31 are subject to processing and control by a video processing and gimbal control unit 32 that also performs data conversion and system power source distribution. A processed video image and audio information are included on a magnetic tape by means of a VTR 33, and image-displayed on a monitor 34. A focus adjustment of the camera 30 and a direction control of the gimabl unit 31 are operated from a photographic control unit 35.

Description Of Operation Of the Prior Art

Now operation of the known art of above constitution is described.

A current position of the helicopter 1 of FIG. 14 is measured based on radio waves from a GPS satellite which waves are received at a GPS receiver via a GPS antenna 36. On the supposition that the radio waves from four GPS satellites are received, a current position of the helicopter 1 can be obtained three-dimensionally. Topographic data including altitude information concerning the ground surface are already stored in a three-dimensionally geographic data storage device 38. As an example of such data, there are three-dimensionally topographic data published by the Japanese Geographical Survey Institute. A position detection device 39 reads out contents stored in the tree-dimensionally geographic data storage device 38 to produce a map image. Further, the position detection device 39 performs outputs regarding one's helicopter position based on outputs from a GPS receiver 37. Furthermore, the position detection device 39 performs outputs regarding direction of the nose of the helicopter 1 facing, or outputs such as date or time of filming, and further performs display of an object and compensation thereof.

A data processing unit 40 performs a position computing of the object in response to the outputs from the position detection device 39, and performs an image data processing in order to conduct a two-dimensional display as shown in FIG. 17. Communication between an operator (cameraman) of the camera 30 and a pilot of the helicopter 1 is carried out via an on-board communication system 41. The image data, which is processed by the data processing unit 40, are transmitted to a transmission unit 43 via a distributing unit 42, and transmitted as radio waves from a transmission antenna 44. The transmission antenna 44 is controlled by means of an automatic tracking unit 45, and directed toward an on-site headquarter command vehicle 7 or a disaster countermeasures office 10 shown in FIG. 15. Although the automatic tracking unit 45 is not always required, mounting the automatic tracking unit 45 enables to efficiently transmit the processed image data far away even if an electric power for transmission from the transmission antenna 44 is small. The distributing unit 42 selects a transmission item, makes a transmission control, and distributes the signals and so on. The transmission unit 43 transmits image, sound or data selected at the distributing unit 42. The image to be transmitted can be seen on the monitor 34.

FIG. 19 shows a receiving constitution at the disaster countermeasures office 10 for receiving radio wave signals such as image transmitted from the devices of the helicopter 1 shown in FIG. 18. An operation table 14 includes a data processing unit 50, a map image generation unit 51 and the like. The data processing unit 50 processes the received image data and conducts a data conversion. The map image generation unit 51 generates a two-dimensional map image or a three-dimensional map image, or performs outputs of, e.g., date and time.

An automatic tracking aerial device 11 includes an automatic tracking antenna 55, an antenna control unit 56, a receiving unit 57 and the like. As the automatic tracking antenna 55, an antenna of a high gain and great directivity is utilized, and direction of beams spread from the automatic tracking antenna 55 is controlled by the antenna control unit 56 so as to be in a direction of the helicopter 1. The receiving unit 57 receives the radio waves, which the automatic tracking antenna 55 has received. The received data of each item including, e.g., image data are inputted to the data processing unit 50.

The data processing unit 50 image-displays processing results such as image data received from the helicopter 1 on a monitor 60 in time of disaster provided within a large-sized projector 13, and recodes it on a VTR 61. A two-dimensional map image as shown in FIG. 17 is displayed on the monitor 60, and this two-dimensional map image is included on the VTR 61. The two-dimensional map image as shown in FIG. 17 is displayed in order to reduce damages resulted from the disaster at the time of occurrence of any disaster. A three-dimensional map image is displayed on a monitor 62 in order to control peacetime operations. The three-dimensional map image displays three-dimensionally obstacles such as mountains around the helicopter 1, and urges a pilot of the helicopter to operate with care. The three-dimensional map image is generated at a map image generation unit 51 based on outputs regarding position of one's helicopter from the position detection device 39 of FIG. 18, and included also on a VTR 63.

Image data, which are shot by the camera 30 of FIG. 18, are displayed on a monitor 65 provided at a control device 12, and included on a VTR 66. The camera 30 shown in FIG. 18 comprises the TV camera 30a for use in a visible light and the infrared camera 30b for use in an infrared light, thereby enabling to obtain a video picture any time day or night by suitably switch these cameras. In general, the TV camera 30a is used in the daytime, and the infrared camera 30b is used at night. When a fire disaster occurs, the TV camera 30a can also be used even at night. On the contrary, even in the daytime, the infrared camera 30b is used when good video pictures cannot be obtained with the use of the TV camera 30a due to fog or smoke.

Descriptions of problems of the prior art

In the conventional method and apparatus for specifying position arranged as described above, an object point is specified by specifying the object point only with a video picture having been shot, and indicating the object point with this video picture. However, since any gap between video picture information to be used and an actual point cannot be confirmed, or an error cannot be confirmed, a problem exits in that it is difficult to determine an object point with high accuracy. Moreover, another problem exists in that a wide range of information incapable of being shot with one video picture cannot be obtained from one video picture, thereby making it hard to determine a wide range of object region extending over a plurality of video pictures.

### SUMMARY OF THE INVENTION

A first object of the present invention is to provide a video picture processing method in which a video picture is displayed being superimposed on a map of a geographic information. system thereby making it easy to ascertain conformability between video picture information and the map, and enabling to determine an object point easily.

To accomplish the foregoing object, the invention provides a video picture processing method intending to take a shot of a ground surface from a video camera mounted on an airframe in the air and identify situations existing on the ground surface, wherein a photographic position in the air is specified three-dimensionally, a photographic range of the ground surface having been shot is computed, a video picture is transformed in conformity with the photographic range, and thereafter the transformed picture is displayed in such a manner as being superimposed on a map of a geographic information system.

A second object of the invention is to provide a video picture processing method in which video pictures are displayed on a map of a geographic information system in a manner of being superimposed, the method being capable of identifying situations of the ground while confirming a wide range of positional relation with a map and a plurality of serial video pictures.

To accomplish the foregoing object, the invention provides a video picture processing method intending to take a shot of a ground surface in succession from a video camera mounted on an airframe in the air and identify situations existing on the ground surface, wherein a photographic position in- the air is specified three- dimensionally, each of a plurality of photographic ranges of the ground surface having been shot in succession are computed, each video picture is transformed in conformity with each of the photographic ranges, and thereafter the plurality of video pictures are displayed in such a manner as being superimposed on a map of a geographic information system.

A third object of the invention is to provide a video picture processing method in which a video picture is displayed on a map of a geographic information system in a manner of being superimposed, the method being capable of identifying more accurate situations of the ground while confirming a positional relation between a video picture and a map by computing a photographic frame with posture of a camera acting as a video camera with respect to the ground.

To accomplish the foregoing object, the invention provides a video picture processing method intending to take a shot of a ground surface from a video camera mounted on an airframe in the air and identify situations existing on the ground surface, wherein a photographic position in the air is specified three-dimensionally, a video picture having been shot is transmitted in sync with the mentioned airframe position information, camera information and airframe information, a photographic range of the ground surface having been shot is computed on the receiving side, and a video picture is transformed in conformity with the photographic range and thereafter superimposed on a map of a geographic information system to be displayed.

The other objects and features of the invention will become understood from the following description with reference to the accompanying drawings.

### BRIEF DESCRIPTION OF THE DRAWINGS

FIG. 1 is an explanatory block diagram to explain function of a system implementing a video picture processing method according to a first preferred embodiment of the invention.

FIG. 2 is an explanatory block diagram to explain function of a geographic processing system according to the first embodiment.

FIG. 3 is a photograph showing a display screen according to the first embodiment.

FIG. 4 is a photograph showing a display screen obtained by a video picture processing method according to a second embodiment of the invention.

FIGS. 5(a) and (b) are schematic diagrams to explain a third embodiment of the invention.

FIGS. 6(a), (b), (c) and (d) are schematic diagrams to explain a geographic processing in the third embodiment.

FIGS. 7(a) and (b) are schematic diagrams to explain a fourth embodiment of the invention.

FIGS. 8(a), (b), (c) and (d) are schematic diagrams to explain a geographic processing in the fourth embodiment.

FIGS. 9(a) and (b) are schematic diagrams to explain a fifth embodiment of the invention.

FIGS. 10(a), (b), (c), (d), (e) and (f) are schematic diagrams to explain a geographic processing in the fifth embodiment.

FIG. 11 is a schematic diagram to explain a geographic processing of a video picture processing method according to a sixth embodiment of the invention.

FIG. 12 is a schematic diagram to explain a geographic processing of a video picture processing method according to a seventh embodiment of the invention.

FIGS. 13(a) and (b) are schematic diagrams to explain a video picture processing method according to an eighth embodiment of the invention.

FIG. 14 is a schematic view showing a basic constitution of a conventional apparatus.

FIG. 15 is a schematic view showing a constitution of the conventional disaster photographic system.

FIGS. 16 (1) and (2) are a conventional aerial video picture and a partially enlarged view thereof.

FIG. 17 is a conventional two-dimensional indicator chart of a disaster occurrence point.

FIG. 18 is a block diagram showing a conventional on-board electrical arrangement.

FIG. 19 is a block diagram showing a conventional electrical arrangement of the devices in a disaster countermeasures office.

### DETAILED DESCRIPTION OF THE PREFERRED EMBODIMENTS

Embodiment 1.

First, outline of the present invention is briefly described. The invention provides a video picture processing method in which a video picture of the ground having been shot aerially is displayed in a manner of being superimposed on a map of a geographic information system (GIS=Geographic Information System, which is a system of displaying a map on a computer screen), thereby making it easy to confirm conformability between video picture information and a map, and to determine an object point (target). However, in the case of shooting a picture of the ground aerially, since the video picture is always taken in a definite shape of rectangle irrespective of direction of the camera, a video picture having been shot cannot be superimposed (pasted) as it is onto a map obtained by a geographic information system. To overcome this, in the invention, a photographic range (=photographic frame) of the ground surface to be shot which photographic frame complicatedly varies from a rectangle to a trapezoid or substantially lozenge is obtained by calculation using camera information and posture information of an airframe at the time of taking a video picture based on, e.g., posture of the camera with respect to the ground. Then a video picture is transformed in conformity with the image frame, pasted onto the map, and displayed.

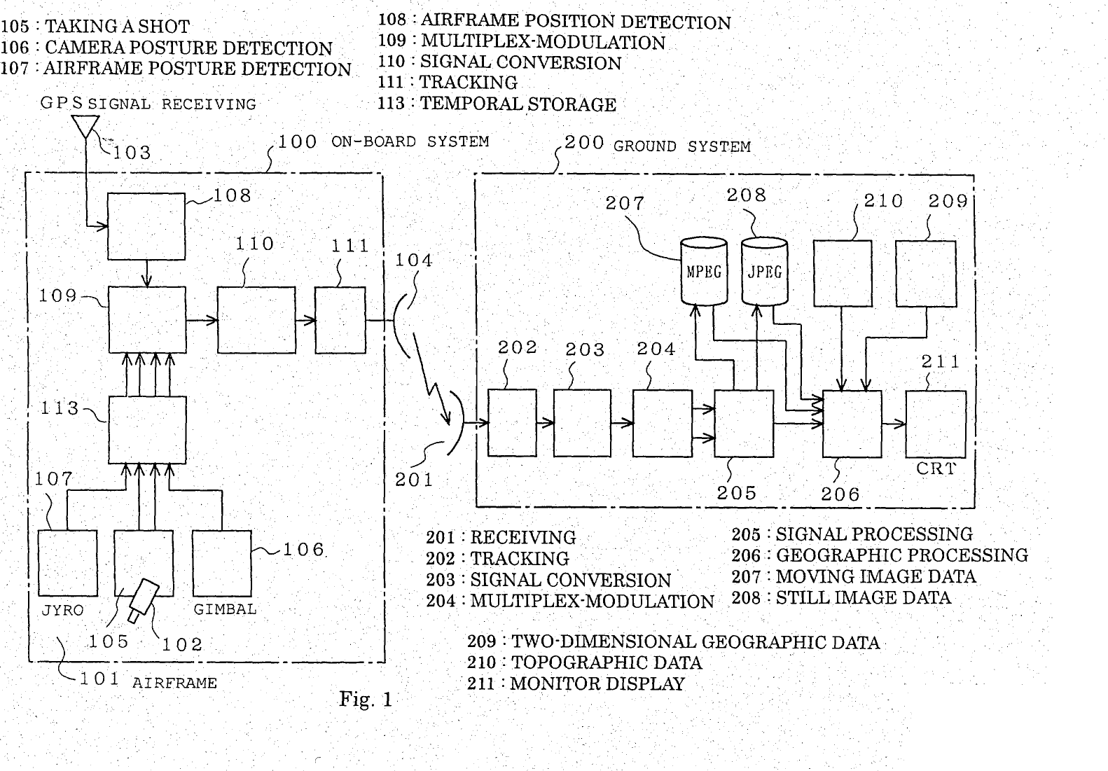

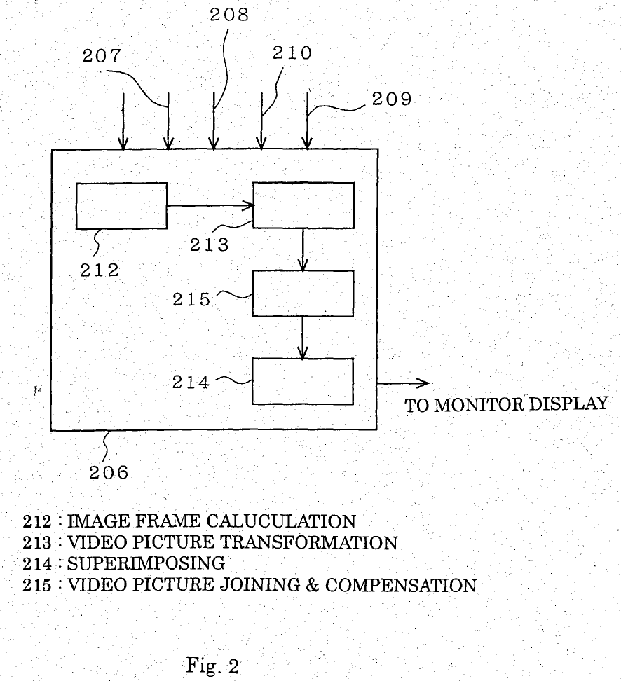

Hereinafter, a video picture processing method according to a first preferred embodiment of the invention is described referring to the drawings. FIG. 1 is an explanatory block diagram to explain with blocks each function of a system for implementing the method of the invention. FIG. 2 is an explanatory block diagram to explain a geographic processing. The method according to the invention is performed by an on-board system 100 including a flight vehicle (=airframe) such as helicopter on which a video camera (=camera) and the like are mounted, and a ground system 200 provided on the ground to receive and process signals from the on-board system 100.

In the on-board system 100, a camera 102 acting as a video camera for shooting a picture of the ground from in the air is mounted onto an airframe 101. The airframe 101 obtains current position information by GPS signal reception 103 with an antenna, and conducts airframe position detection 108. The airframe 101 is provided with a gyro, and conducts airframe posture detection 107 for detecting a posture of the airframe 101, that is an elevation angle (=pitch) and roll angle.

The camera 102 acting as the video camera takes a shot of the ground 105, outputs video picture signals thereof, as well as outputs together camera information such as diaphragm and zoom of the camera. The camera 102 is attached to a gimbal, and this gimbal conducts camera posture detection 106 detecting a rotation angle and inclination (=tilt) of the camera, and outputs signals thereof.

An output signal of the above-mentioned airframe position detection 108, an output signal of the airframe posture detection 107, a video picture signal and a camera information signal of the camera shooting 105, an output signal of the camera posture detection 106 are multiplex-modulated 109 by a modulator. These signals are signal-converted 110 to digital signals, and transmitted 104 to the ground system 200 from an antenna having a tracking 111 function.

In the ground system 200, the signals from the on- board system 100 are received with an antenna possessing a tracking 202 function, signal-converted 203, and multiplex-demodulated 204. Thus, a video picture signal and other information signals such as airframe position, airframe posture, camera posture, camera information and the like are fetched out. The fetched-out signals are signal-processed 205, and the video picture signals are subject to geographic processing 206 in the next step as moving image data (MPEG) 207 and still image data (JPEG). Other information signals are also used in the geographic processing 206.

The geographic processing 206 performs functions shown in FIG. 2. In the geographic processing 206, as shown in FIG. 2, processing is conducted with the use of moving image data 207 and the still image data 208, which are video picture signals, the information signal such as an airframe position, airframe posture and camera posture, and a two-dimensional geographic data 209 and a three-dimensional topographic data 210.

In the geographic processing 206, first, image frame calculation 212 is conducted, whereby a photographic position in the air is specified three-dimensionally, and a photographic range (=photographic frame) of the ground surface having been shot is obtained by calculation based on posture of the camera and airframe with respect to the ground surface. Video picture transformation 213 is carried out in conformity with this image frame. The video picture transformation is to transform a video picture into a trapezoid, substantially lozenge or the like, in which a video picture is coincident to the map. Next, the transformed video picture is superimposed (pasted) 214 on a map of the geographic information system. Thereafter this resultant is monitor-displayed 211 with a CRT or the like.

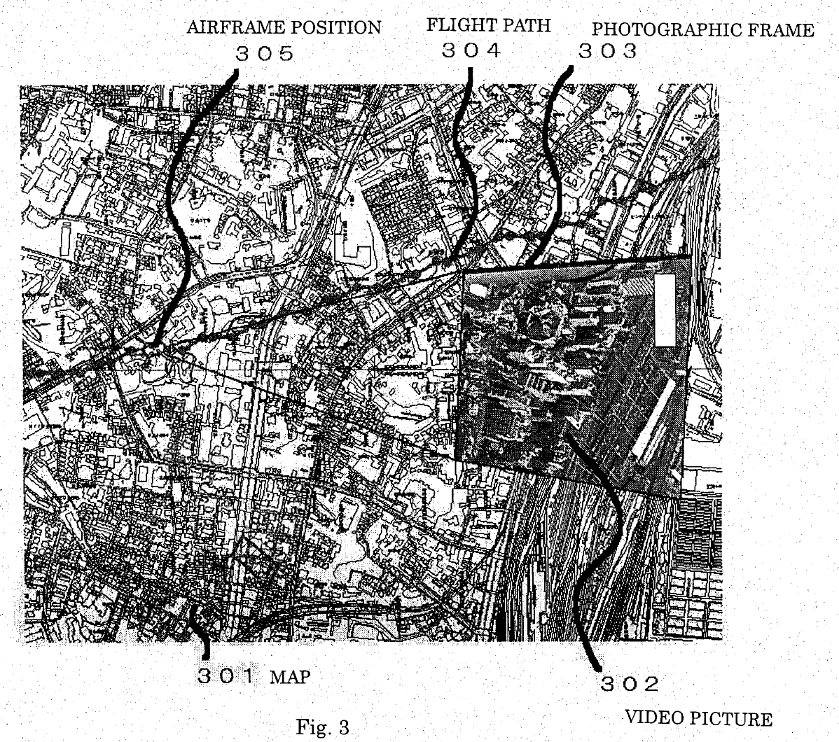

FIG. 3 shows a photograph in which a video picture 302 is superimposed on a map 301 of the geographic information system with a photographic frame 303 conforming to the map. Reference numeral 304 designates a flight path of the airframe, and numeral 305 designates an airframe position (camera position) Implementation of geographic processing 206 including the above-mentioned transformation processing brings a video picture and map to be more accurately coincident to each other, as shown in FIG. 3, and makes it easy to ascertain conformability between a video picture information and a map, thereby enabling to determine an object point (target) easily.

In addition, as shown in FIG. 3, a video picture of an image frame having been shot with the camera can be displayed in a manner of being superimposed on the map. It can be also easily conducted to erase the video picture 302 and display only the image frame 303. In FIG. 3, the video picture 302 is superimposed on the two-dimensional map. Accordingly, for example, place of the disaster occurring (e.g., building on fire) is viewed in the video picture 302, and the position thereof is checked (clicked) on the video picture 302. Thereafter, the video picture 302 is erased, and the two-dimensional map under the video picture 302 is displayed in the form of displaying only the image frame 303, thereby enabling to quickly recognize where position having been checked on the video picture corresponds to on the map. Further, supposing that video pictures on the monitor are arranged in such a manner as to be displayed in a definite direction irrelative to direction of the camera, determination or discrimination of an object point becomes easier.

Embodiment 2.

In this embodiment, a current position of the airframe 101 is measured, and a photographic frame of the ground having been shot from on board is calculated on a map of a geographic information system. Then a video picture having been shot is transformed and pasted in conformity with the photographic frame. When matching (collating) between a video picture and a map is carried out, video pictures having been shot continuously are sampled on cycles of a predetermined period in such a manner as a plurality of video pictures being sampled in succession. Further, a series of plural video pictures are pasted onto the map of the geographic information system to be displayed thereon. Thus an object point is specified from the video pictures pasted onto the map.

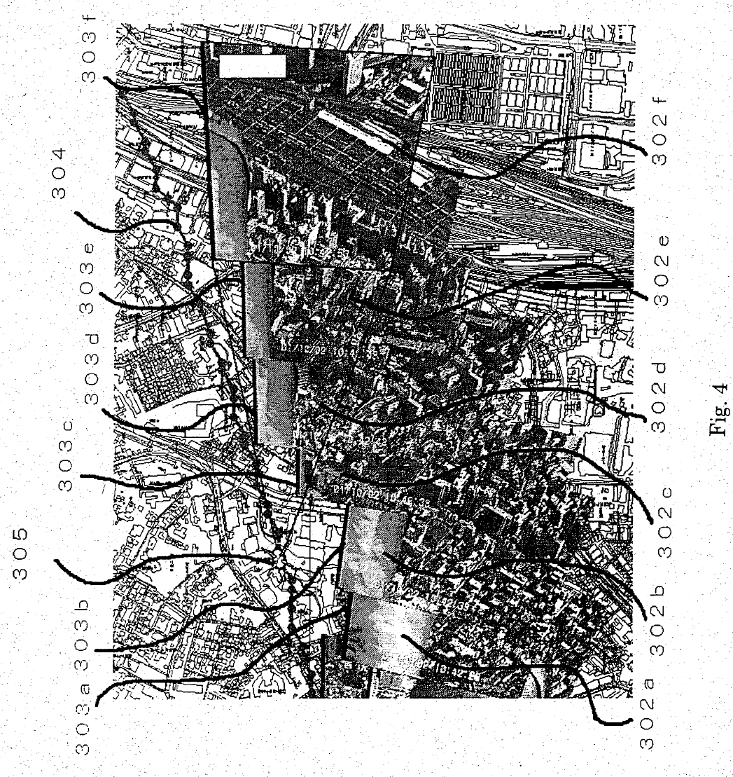

FIG. 4 shows a monitor display screen according to this method. Numeral 301 designates a map. Numeral 304 designates a flight path of the airframe. Numeral 305 designates an airframe position (camera position). Video pictures having been shot from the camera along the flight path 304 are sampled at a predetermined timing to obtain each image frame, and the video pictures are transformed and processed so as to conform to the image frames and pasted onto the map 301. Numerals 302a through 302f are pasted video pictures. Numerals 303a through 303f are image frames thereof.

Calculation of the photographic frame and transformation of the video picture into each image frame are carried out by calculation using camera information and posture information of the airframe at the time of taking a shot as described in the foregoing first embodiment. It is preferable that a sampling period for each image frame is changed in accordance with speed of the airframe. Normally, a sampling period is set to be small when the airframe flies fast in speed, and it is set to be large when the airframe flies slow in speed.

In this embodiment, it becomes possible to identify situations of the ground while confirming situations of a wide range of ground surface with the map and a plurality of video pictures in succession thereby enabling to determine an object point further effectively.

Embodiment 3.

In this embodiment, a current position of the airframe 101 and a rotation angle and inclination (posture of the camera) of the camera 102 with respect to the airframe are measured. Then a photographic frame of the ground having shot from on board is calculated on a map of a geographic information system based on this camera posture. Further a video picture having been shot are transformed and pasted in conformity with this photographic frame, and matching (collating) between the video picture and the map is carried out.

In this embodiment, the photographic frame is calculated based on posture of the camera acting as a video camera, thereby confirming more accurate situations of the ground while enabling to identify a positional relation between the video picture and the map.

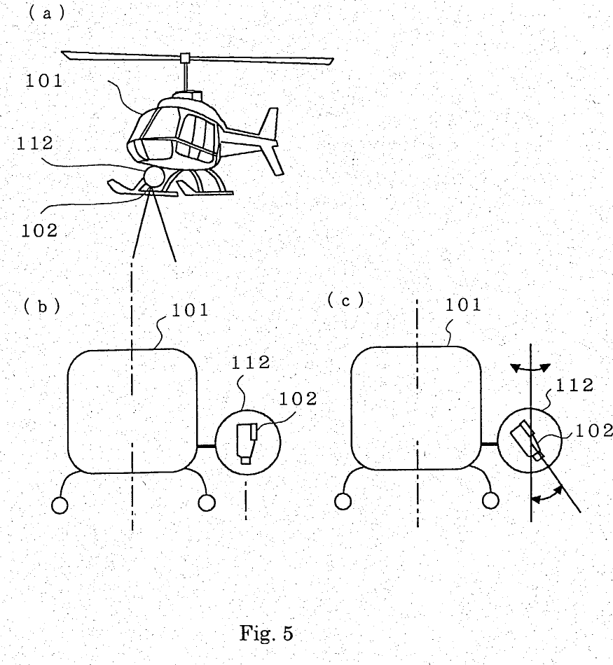

Now, relations between the airframe 101 and the camera 102 are shown in FIGS. 5(a) and (b). On the assumption that the camera 102 is housed in a gimbal 112, and the airframe 101 flies level, as shown in FIGS. 5(b) and (c), inclination of the camera 102 is outputted as inclination (=tilt) of the airframe 101 with respect to a central axis. A rotation angle of the camera 102 is outputted as a rotation angle from a traveling direction of the airframe 101. More specifically, in a state of (b), the camera 102 faces right below and therefore the inclination is 0 degree. In a state of (c), inclination of the camera 102 is shown to be an inclination with respect to a vertical plane.

A method for computing photographic frames of the camera can be obtained as a basis of computer graphics by a rotational movement and a projection processing of rectangles (image frames) in three-dimensional coordinates.

Basically, a photographic frame of the camera is conversion-processed with camera information and airframe information, and a graphic frame in the case of casting a reflection of (projecting) this photographic frame onto the ground is calculated, thereby enabling to obtain a target image frame.

A method for calculating each coordinate in 3D coordinates is achieved by using the following calculation method of matrix:

1) Calculation of a photographic frame in a reference state.

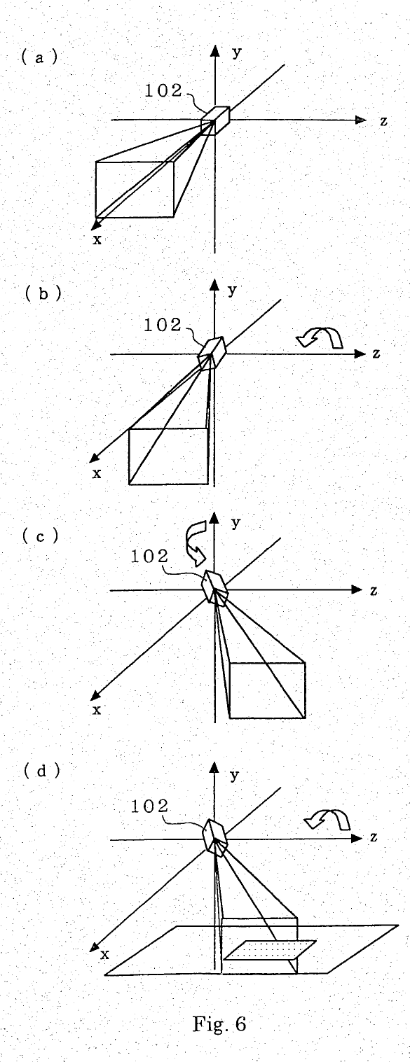

First, as shown in FIG. 6(a), positions of four points of an image frame are calculated as relative coordinates establishing a position of the airframe as the origin. The photographic frame is calculated at a reference position with a focal length, angle of view and altitude of the camera, thereby obtaining coordinates of four points.

2) Calculating positions of four points after rotation about tilt of the camera (Z-axis).

As shown in FIG. 6(b), a photographic frame is rotated on the Z-axis in accordance with a tilt angle of the camera. Coordinates after rotation are obtained by transformation with the following Expression 1.

$$[ \begin{matrix}{x}^{′} & {y}^{′} & {z}^{′} & 1\end{matrix} ] = [ \begin{matrix}x & y & z & 1\end{matrix} ] [ \begin{matrix}cos \hat{a} ⊨ & sin \hat{a} ⊨ & 0 & 0 \\ - sin \hat{a} ⊨ & cos \hat{a} ⊨ & 0 & 0 \\ 0 & 0 & 1 & 0 \\ 0 & 0 & 0 & 1\end{matrix} ] \qquad Expression 1$$

3) Calculating positions of four points after rotation about azimuth of the camera (Y-axis).

As shown in FIG. 6(c), a photographic frame is rotated on the Y-axis in accordance with azimuth of the camera. Coordinates after rotation are obtained by transformation with the following Expression 2.

$$[ \begin{matrix}{x}^{′} & {y}^{′} & {z}^{′} & 1\end{matrix} ] = [ \begin{matrix}x & y & z & 1\end{matrix} ] [ \begin{matrix}cos \hat{a} ⊨ & 0 & - sin \hat{a} ⊨ & 0 \\ 0 & 1 & 0 & 0 \\ sin \hat{a} ⊨ & 0 & cos \hat{a} ⊨ & 0 \\ 0 & 0 & 0 & 1\end{matrix} ] \qquad Expression 2$$

4) Calculating a graphic frame of casting a reflection of the image frame after the rotation processing based on the foregoing Expressions 1 and 2 onto a ground surface (Y-axis altitude point) from the origin (airframe position).

As shown in FIG. 6(d), a projection plane (photographic frame) is obtained by projecting the photographic frame onto the ground surface (Y-axis altitude). Coordinates after projection are obtained by transformation with the following Expression 3.

$$[ \begin{matrix}{x}^{′} & {y}^{′} & {z}^{′} & 1\end{matrix} ] = [ \begin{matrix}x & y & z & 1\end{matrix} ] [ \begin{matrix}1 & 0 & 0 & 0 \\ 0 & 1 & 0 & 1 / d \\ 0 & 0 & 1 & 0 \\ 0 & 0 & 0 & 0\end{matrix} ] \qquad Expression 3$$

Generalized homogenous coordinate system [X, Y, Z, W] is obtained with the following Expression 4. In addition, alphabet d designates an above sea level altitude.

[X Y Z W]=[X y z y/d] Expression 4

Next, the expression 4 is divided by W′(=y/d) and restored to be 3D, thereby the following Expression 5 is obtained.

$$[ \begin{matrix}\frac{X}{W} & \frac{Y}{W} & \frac{Z}{W} & 1\end{matrix} ] = [ \begin{matrix}xp & yp & zp & 1\end{matrix} ] = [ \begin{matrix}\frac{x}{y / d} & d & \frac{z}{y / d} & 1\end{matrix} ]$$

Embodiment 4.

In this embodiment, a current position of the airframe 101, and an elevation angle and roll angle of the airframe 101 are measured, and a photographic frame of the ground having been shot from on board is calculated on a map of a geographic information system with these elevation angle and roll angle. Then a video picture having been shot is transformed and pasted in conformity with the photographic frame, and matching between the video picture and the map is carried out. In this embodiment, the photographic frame is computed from position information of the airframe 101 with respect to the ground, thereby confirming more accurate situations of the ground while enabling to identify a positional relation between the video picture and the map.

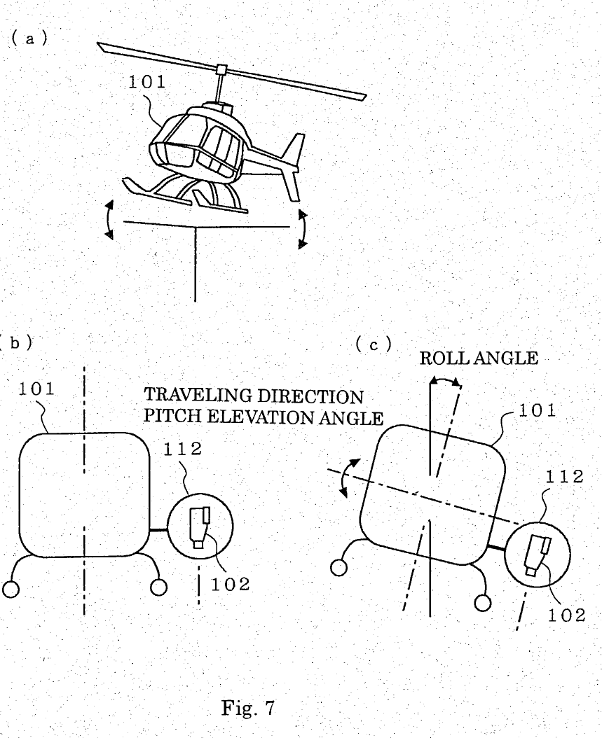

Now, relations between the airframe and the camera are shown in FIGS. 7(a) and (b). On the assumption that the camera 102 is fixed to the airframe 101 (that is, gimbal is not used), when the airframe 101 itself flies horizontally with respect to the ground as shown in FIG. 7 (b), the camera 102 faces right below and therefore inclination of the camera 102 becomes 0 degree. In the case where the airframe 101 inclines as shown in FIG. 7 (c), this inclination is a posture of the camera 102 and therefore a photographic frame of the camera is calculated based on an elevation angle (pitch) and roll angle of the airframe 101.

1) Calculation of a photographic frame in a reference state.

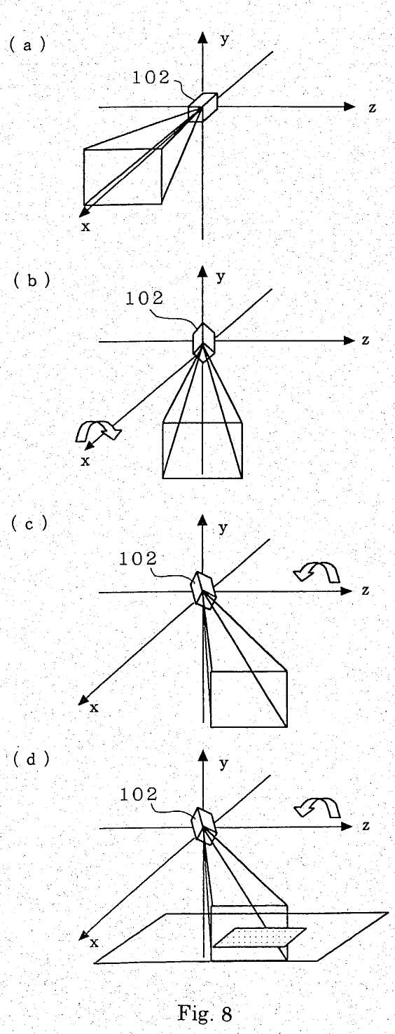

As shown in FIG. 8(a), positions of four points of an image frame are calculated as relative coordinates establishing a position of the airframe as the origin. The photographic frame is calculated at a reference position with a focal length, angle of view and altitude of the camera, thereby obtaining coordinates of four points.

2) Calculating positions of four points after rotation about roll of the airframe (X-axis).

As shown in FIG. 8(b), the photographic frame is rotated on the X-axis in accordance with a roll angle of the airframe with the following expression. Coordinates after rotation are obtained by transformation with the following expression 6.

$$[ \begin{matrix}{x}^{′} & {y}^{′} & {z}^{′} & 1\end{matrix} ] = [ \begin{matrix}x & y & z & 1\end{matrix} ] [ \begin{matrix}cos \hat{a} ⊨ & sin \hat{a} ⊨ & 0 & 0 \\ - sin \hat{a} ⊨ & cos \hat{a} ⊨ & 0 & 0 \\ 0 & 0 & 1 & 0 \\ 0 & 0 & 0 & 1\end{matrix} ] \qquad Expression 6$$

3) Calculating positions of four points after rotation about pitch of the airframe (Z-axis)

As shown in FIG. 8(c), the photographic frame is rotated on the Z-axis in accordance with a pitch angle of the airframe. Coordinates after rotation are obtained by transformation with the following expression 7.

$$[ \begin{matrix}{x}^{′} & {y}^{′} & {z}^{′} & 1\end{matrix} ] = [ \begin{matrix}x & y & z & 1\end{matrix} ] [ \begin{matrix}cos \hat{a} ⊨ & 0 & - sin \hat{a} ⊨ & 0 \\ 0 & 1 & 0 & 0 \\ sin \hat{a} ⊨ & 0 & cos \hat{a} ⊨ & 0 \\ 0 & 0 & 0 & 1\end{matrix} ] \qquad Expression 7$$

4) Calculating a graphic frame of casting a reflection of the image frame after the rotation processing based on the foregoing Expressions 6 and 7 onto a ground surface (Y-axis altitude point) from the origin (airframe position).

As shown in FIG. 8(d), a projection plane (photographic frame) is obtained by projecting the photographic frame onto the ground surface (Y-axis altitude). Coordinates after projection are obtained by transformation with the following expression 8.

$$[ \begin{matrix}{x}^{′} & {y}^{′} & {z}^{′} & 1\end{matrix} ] = [ \begin{matrix}x & y & z & 1\end{matrix} ] [ \begin{matrix}1 & 0 & 0 & 0 \\ 0 & 1 & 0 & 1 / d \\ 0 & 0 & 1 & 0 \\ 0 & 0 & 0 & 0\end{matrix} ] \qquad Expression 8$$

Generalized homogenous coordinate system [X, Y, Z, W] is obtained with the following expression 9.

[X Y Z W]=[x y z y/d] Expression 9

Next, the expression 9 is divided by W′(=y/d) and restored to 3D, thereby the following expression 10 is obtained.

$$\begin{matrix}[ \begin{matrix}\frac{X}{W} & \frac{Y}{W} & \frac{Z}{W} & 1\end{matrix} ] = [ \begin{matrix}xp & yp & zp & 1\end{matrix} ] = [ \begin{matrix}\frac{x}{y / d} & d & \frac{z}{y / d} & 1\end{matrix} ] & \end{matrix} \qquad Expression 10$$

Embodiment 5.

In this embodiment, a current position of the airframe 101, a rotation angle and inclination of the camera 102 with respect to the airframe, and further an elevation angle and roll angle of the airframe 101 are measured, and a photographic frame of the ground having been shot from on board is calculated on a map of a geographic information system with these information. Then a video picture having been shot is transformed and pasted in conformity with the photographic frame, and matching between the video picture and the map is conducted. In this embodiment, the photographic frame is computed with posture information of the camera and posture information of the airframe, thereby confirming more accurate situations of the ground while enabling to identify a positional relation between the video picture and the map.

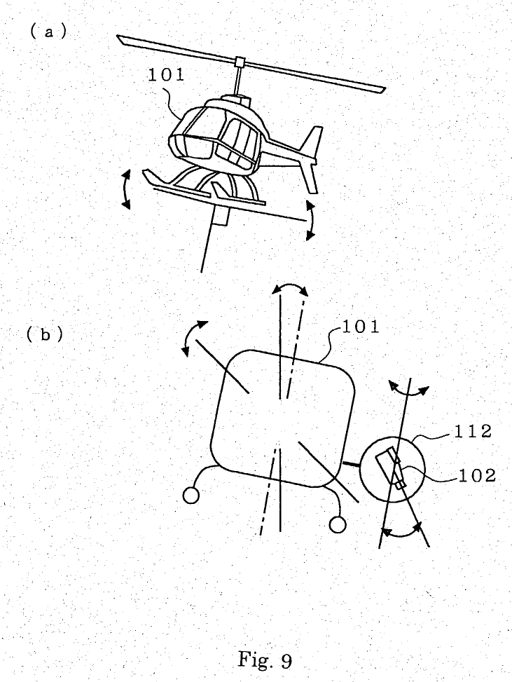

Now, relations between the airframe 101 and the camera 102 are shown in FIGS. 9(a) and (b) On the assumption that the camera 102 is housed in the gimbal 112, and the airframe 101 flies in any posture, inclination and rotation angle of the camera 102 are outputted from the gimbal 112 as shown in FIG. 9(b) Furthermore, an elevation angle and roll angle of the airframe 101 of itself with respect to the ground are outputted from the gyro.

A method for calculating a photographic frame of the camera can be obtained by a rotational movement and a projection processing of rectangles (image frames) in 3D coordinates as a basis of computer graphics.

Basically, a photographic frame of the camera are conversion-processed with camera information and airframe information, and a graphic frame at the time of casting a reflection of the photographic frame onto the ground is calculated, thereby enabling to obtain a target image frame.

A method for calculating each coordinate in 3D coordinates is obtained by using the following calculation method of matrix.

1) Calculation of a photographic frame in a reference state.

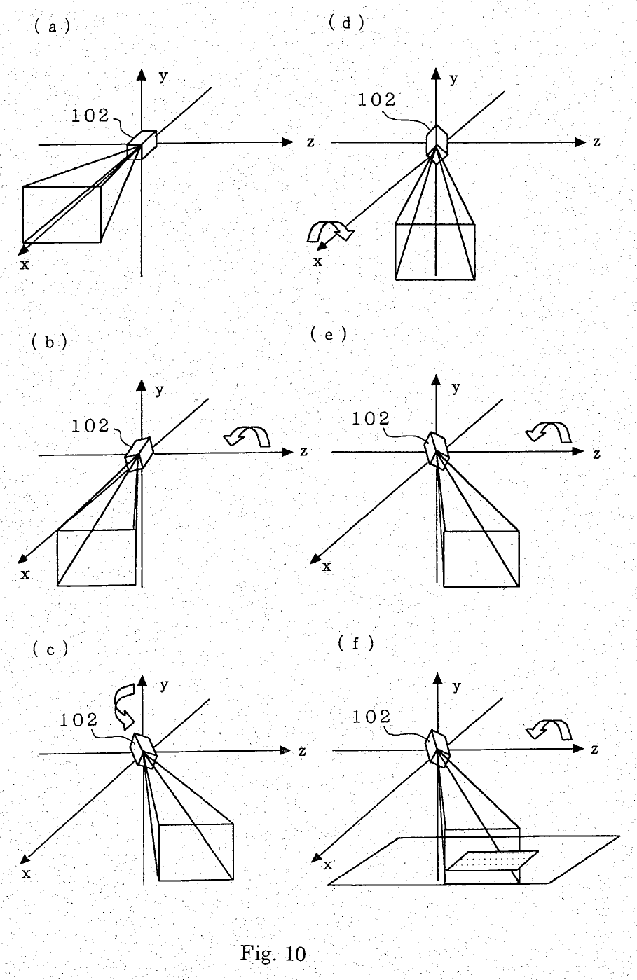

As shown in FIG. 10(a), positions of four points of an image frame are calculated as relative coordinates establishing a position of the airframe as the origin. A photographic frame is calculated at a reference position with a focal length, angle of view and altitude of the camera, thereby obtaining coordinates of four points.

2) Calculating positions of four points after rotation about tilt of the camera (Z-axis).

As shown in FIG. 10(b) a photographic frame is rotated on the Z-axis in accordance with a tilt angle of the camera to be transformed. Coordinates after rotation are obtained by transformation with the following expression 11.

$$[ \begin{matrix}{x}^{′} & {y}^{′} & {z}^{′} & 1\end{matrix} ] = [ \begin{matrix}x & y & z & 1\end{matrix} ] [ \begin{matrix}cos \hat{a} ⊨ & sin \hat{a} ⊨ & 0 & 0 \\ - sin \hat{a} ⊨ & cos \hat{a} ⊨ & 0 & 0 \\ 0 & 0 & 1 & 0 \\ 0 & 0 & 0 & 1\end{matrix} ] \qquad Expression 11$$

3) Calculating positions of four points after rotation about azimuth of the camera (Y-axis)

As shown in FIG. 10(c), a photographic frame is rotated on the Y-axis in accordance with azimuth of the camera to be transformed. Coordinates after rotation are obtained by transformation with the following expression 12.

$$[ \begin{matrix}{x}^{′} & {y}^{′} & {z}^{′} & 1\end{matrix} ] = [ \begin{matrix}x & y & z & 1\end{matrix} ] [ \begin{matrix}cos \hat{a} ⊨ & 0 & - sin \hat{a} ⊨ & 0 \\ 0 & 1 & 0 & 0 \\ sin \hat{a} ⊨ & 0 & cos \hat{a} ⊨ & 0 \\ 0 & 0 & 0 & 1\end{matrix} ] \qquad Expression 12$$

4) Calculating positions of four points after rotation about roll of the airframe (X-axis)

As shown in FIG. 10(d), a photographic frame is rotated on the X-axis in accordance with a roll angle of the airframe to be transformed. Coordinates after rotation are obtained by transformation with the following expression 13.

$$[ \begin{matrix}{x}^{′} & {y}^{′} & {z}^{′} & 1\end{matrix} ] = [ \begin{matrix}x & y & z & 1\end{matrix} ] [ \begin{matrix}1 & 0 & 0 & 0 \\ 0 & cos \hat{a} ⊨ & sin \hat{a} ⊨ & 0 \\ 0 & - sin \hat{a} ⊨ & cos \hat{a} ⊨ & 0 \\ 0 & 0 & 0 & 1\end{matrix} ] \qquad Expression 13$$

5) Calculating positions of four points after rotation about pitch of the airframe (Z-axis)

As shown in FIG. 10(e), a photographic frame is rotated on the Z-axis in accordance with a pitch angle of the airframe to be transformed. Coordinates after rotation are obtained by transformation with the following expression 14.

$$[ \begin{matrix}{x}^{′} & {y}^{′} & {z}^{′} & 1\end{matrix} ] = [ \begin{matrix}x & y & z & 1\end{matrix} ] [ \begin{matrix}1 & 0 & 0 & 0 \\ 0 & cos \hat{a} ⊨ & sin \hat{a} ⊨ & 0 \\ 0 & - sin \hat{a} ⊨ & cos \hat{a} ⊨ & 0 \\ 0 & 0 & 0 & 1\end{matrix} ] \qquad Expression 14$$

6) Calculating a graphic frame of casting a reflection of the image frame after the rotation processing based on the foregoing Expressions 11 to 14 onto a ground surface (Y-axis altitude point) from the origin (airframe position)

As shown in FIG. 10(f), a projection plane (photographic frame) is obtained by projecting the photographic frame onto the ground surface (Y-axis altitude). Coordinates after projection are obtained by transformation with the following expression 15.

$$[ \begin{matrix}{x}^{′} & {y}^{′} & {z}^{′} & 1\end{matrix} ] = [ \begin{matrix}x & y & z & 1\end{matrix} ] [ \begin{matrix}1 & 0 & 0 & 0 \\ 0 & 1 & 0 & 1 / d \\ 0 & 0 & 1 & 0 \\ 0 & 0 & 0 & 0\end{matrix} ] \qquad Expression 15$$

7) Generalized homogenous coordinate system [X, Y, Z, W] is obtained with the following expression 16.

[X Y Z W]=[x y z y/d] Expression 16

8) Next, the expression 16 is divided by W′(=y/d) and restored to 3D, thereby the following expression 17 is obtained.

$$[ \begin{matrix}\frac{X}{W} & \frac{Y}{W} & \frac{Z}{W} & 1\end{matrix} ] = [ \begin{matrix}xp & yp & zp & 1\end{matrix} ] = [ \begin{matrix}\frac{x}{y / d} & d & \frac{z}{y / d} & 1\end{matrix} ] \qquad Expression 17$$

Embodiment 6.

In this embodiment, a current position of the airframe 101, a rotation angle and inclination of the camera 102 with respect to the airframe, and further an elevation angle and roll angle of the airframe 101 are measured, and a photographic frame of the ground having been shot from on board is calculated on a map of a geographic information system. In calculation processing of four points of this photographic frame, topographic altitude data are utilized, and a flight position of the airframe 101 is compensated to calculate a photographic frame. Then a video picture is transformed in conformity with the photographic frame and pasted on a map of the geographic information system, and matching between the video picture and the map is conducted.

In this embodiment, information about a position and altitude of the airframe, an airframe posture information and posture information of the camera are used, compensation is carried out based on topographic altitude information of the ground surface, and then the photographic frame is computed, thereby confirming more accurate situations of the ground while enabling to identify a positional relation between the video picture and the map.

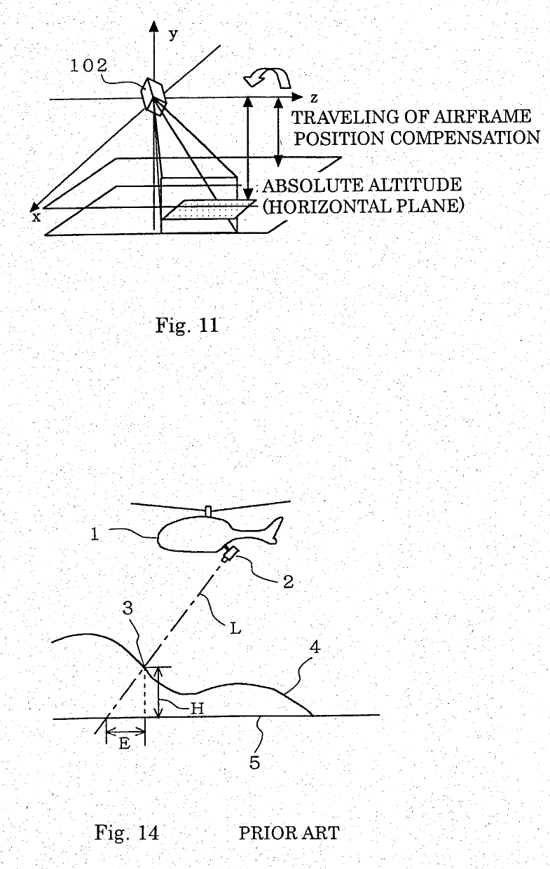

In the above-mentioned fifth embodiment, a sea level altitude obtained from the GPS apparatus is employed as altitude of the airframe in computing a photographic frame after the rotation processing based on the foregoing Expressions 11 to 14 onto the ground surface after rotation. Whereas, in this sixth embodiment, as shown in FIG. 11, a ground altitude (relative altitude d=sea level altitude−ground altitude) at a photographic point is employed as altitude of the airframe utilizing a topographic altitude information of the ground surface, whereby calculation of four points of a photographic frame is implemented.

1) Calculating a graphic frame of casting a reflection of an image frame after the rotation processing based on the foregoing Expressions 11 to 14 onto the ground surface (Y-axis altitude point) from the origin (airframe position)

A projection plane is obtained by projecting the photographic frame onto the ground surface (Y-axis altitude). Coordinates after projection are obtained by transformation with the following expression 18.

$$[ \begin{matrix}{x}^{′} & {y}^{′} & {z}^{′} & 1\end{matrix} ] = [ \begin{matrix}x & y & z & 1\end{matrix} ] [ \begin{matrix}1 & 0 & 0 & 0 \\ 0 & 1 & 0 & 1 / d \\ 0 & 0 & 1 & 0 \\ 0 & 0 & 0 & 0\end{matrix} ] \qquad Expression 18$$

Generalized homogenous coordinate system [X,Y, Z, W] is obtained with the following expression 19.

[X Y Z W]=[x y z y/d] Expression 19

Next, the expression 19 is divided by W′ (=y/d) and restored to 3D thereby the following expression 20 is obtained.

$$[ \begin{matrix}\frac{X}{W} & \frac{Y}{W} & \frac{Z}{W} & 1\end{matrix} ] = [ \begin{matrix}xp & yp & zp & 1\end{matrix} ] = [ \begin{matrix}\frac{x}{y / d} & d & \frac{z}{y / d} & 1\end{matrix} ] \qquad Expression 20$$

A relative altitude d, which is used herein, is obtained by subtracting a topographic altitude at an object point from an absolute altitude from the horizon obtained by the GPS apparatus, and this relative altitude from the camera is utilized. Thus it becomes possible to compute highly accurate positions of photographic frames.

Embodiment 7.

In this embodiment, when measuring a current position of the airframe 101, calculating a photographic frame of the ground having been shot from on board on a map of a geographic information system, transforming and pasting a video picture having been shot in conformity with the photographic frame, and carrying out matching between the video picture and the map, a plurality of video pictures transformed to be pasted on the map are selected in succession and displayed being pasted continuously onto the map of the geographic information system. Then an object point is specified from the pasted video pictures on the map.

In the processing of pasting the plurality of video pictures onto the map of the geographic information system, layout of video pictures is conducted in accordance with the calculated photographic frames, and a joining state of overlapping areas in each video picture is confirmed. Then the video pictures are moved so that overlapping areas of the video pictures may be the largest to conduct position compensation. Subsequently the video pictures are transformed in conformity with the photographic frames on the map of the geographic information system with the use of the compensation values, and the paste processing is carried out.

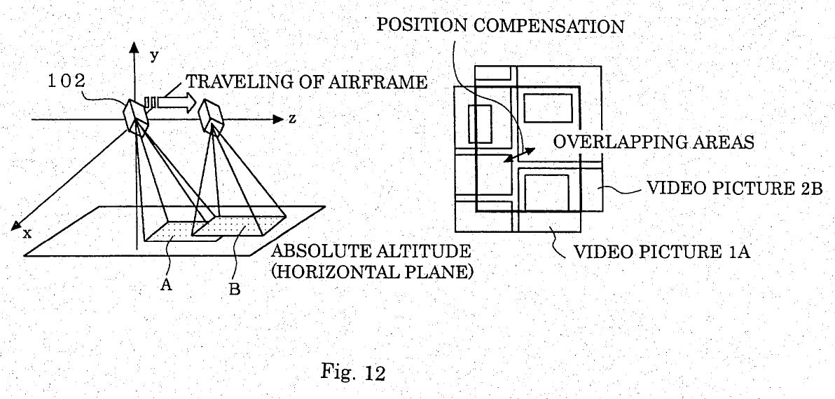

Procedures thereof are shown in FIGS. 12(a) and (b). For example, two pieces of video pictures 1(A) and 2(B), which are taken in accordance with traveling of the airframe 101, are superimposed, and overlapping areas are detected. Then the video pictures 1(A) and 2(B) are moved relatively so that areas of overlap of the video pictures may be the largest, a position compensation value at the time of joining is obtained, a position compensation is conducted, and the video pictures 1 (A) and 2(B) are joined. The position compensation is done at video picture joining & compensation 215 in FIG. 2.

In this embodiment, a plurality of continuous video pictures provide a more accurate joining, thereby confirming situations of the ground while enabling to identify situations of a wider range of ground surface.

Embodiment 8.

In this embodiment, a current position of the airframe 101, a mounting angle and inclination of the camera 102 with respect to the airframe, and further an elevation angle and roll angle of the airframe 101 are measured. Then a photographic frame of the ground having been shot from on board is calculated on a map of a geographic information system, the video picture is transformed in conformity with the photographic frame to be pasted, and matching between the video picture and the map is carried out.

In the case of carrying out this processing, it comes to be important that various information, which are transmitted from the on-board system 100, are received by the ground system 200 in a state of being perfectly synchronized. To achieve this synchronization, it is necessary to adjust processing times such as processing time at a flight position detector, processing time for detecting posture of the camera by means of the gimbal or processing time of transmitting the video picture, and transmit them in sync with the video image. For that purpose, referring to FIG. 1, a buffer is provided, and video picture signals of the camera on board are temporarily stored 113 in this buffer. Then the picture signals are transmitted to the ground system 200, in sync with delay in time for computing and detecting an airframe position by GPS or the like.

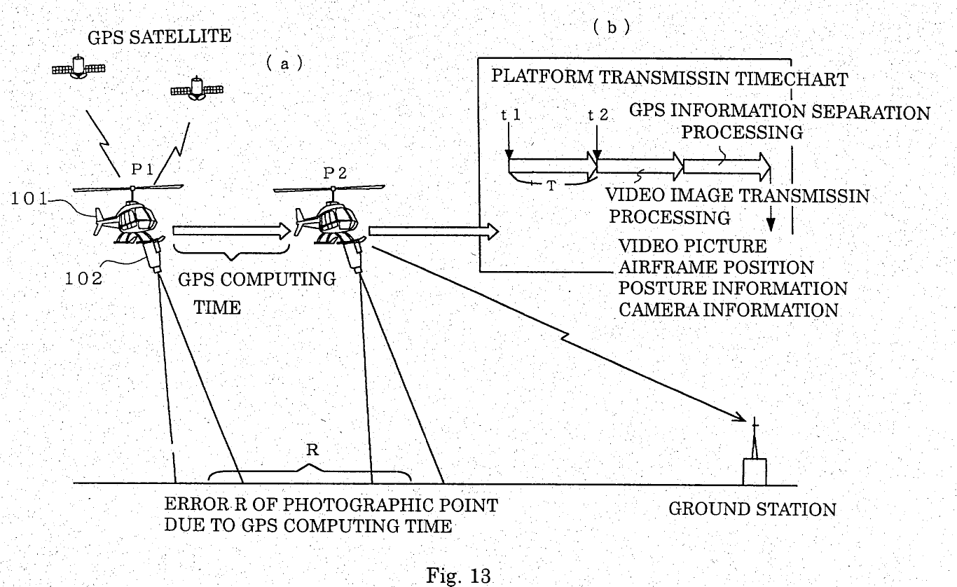

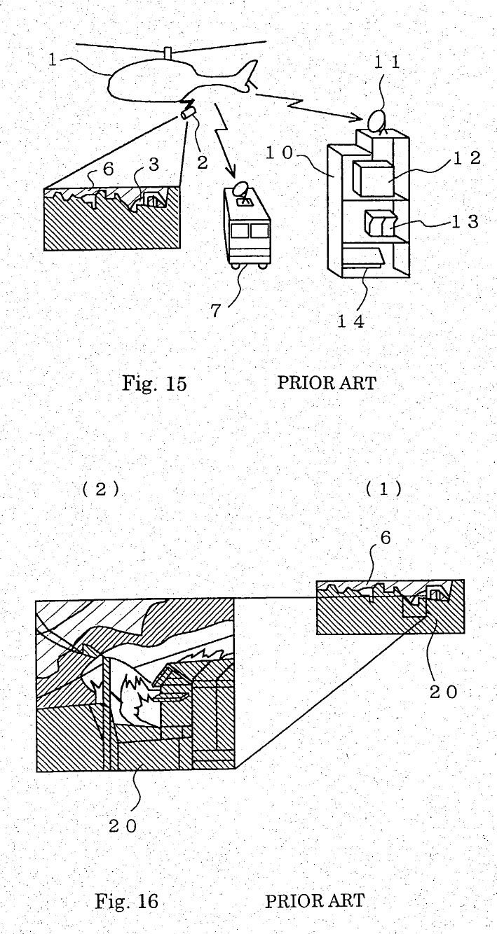

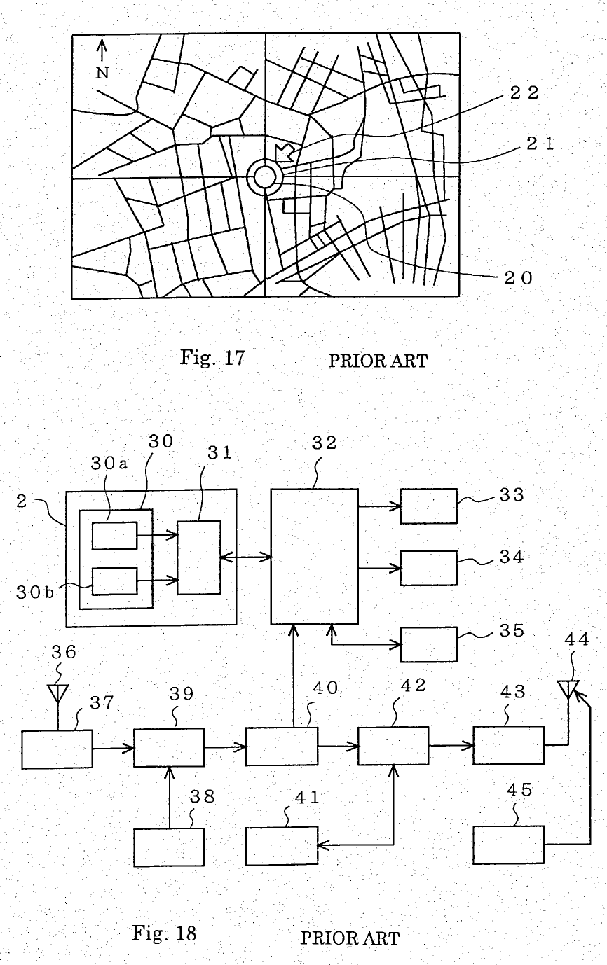

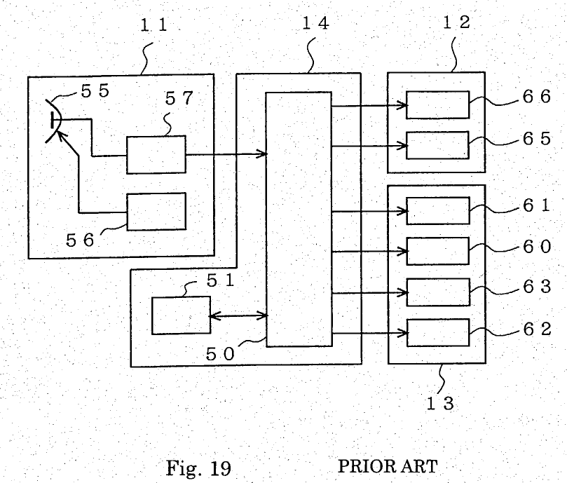

This relation is now explained with reference to FIGS. 13(a) and (b). A time T is required for the airframe 101 to complete the detection of an airframe position after receiving a GPS signal, and the airframe 101 travels from a position P1 to a position P2 during this time. Therefore at the point of time having completed a position detection of the airframe, a region shot with the camera 102 becomes a region apart from that shot at the position P1 just by a distance R, which results in occurrence of error.

FIG. 13(b) is a time chart showing procedures for correcting this error. A video picture signal is temporarily stored in the buffer during a GPS computing time T from a GPS observation point t1 for detecting an airframe position. Then at point t2, the temporarily stored video picture signal is transmitted together with airframe position, airframe posture, camera information and the like.

In this embodiment, photographic frame is calculated based on mounting information of the video camera, thereby enabling to identify more accurate situations of the ground while confirming a positional relation between the video picture and the map.

Furthermore, in processing graphics, video picture processing such as displaying only the image frames left in a manner of being superimposed on the map or displaying the video pictures in a definite direction irrespective of direction of the camera can be easily carried out. This makes it possible to identify situations of the ground further quickly.

What is claimed is:

1. A video picture processing method intending to take a shot of a ground surface from a video camera mounted on an airframe in the air and identify situations existing on the ground surface;
the method comprising the steps of: specifying three-dimensionally a photographic position in the air; computing a photographic range of the ground surface having been shot; transforming a video picture in conformity with the photographic range; and displaying the transformed picture in such a manner as being superimposed on a map of a geographic information system.

2. The video picture processing method according to claim 1, wherein a photographic range of the ground surface having been shot is computed based on an inclination and rotation angle of said video camera with respect to said airframe.

3. The video picture processing method according to claim 1, wherein a photographic range of the ground surface having been shot is computed based on an inclination and roll angle of said airframe with respect to the ground surface.

4. The video picture processing method according to claim 1, wherein a photographic range of the ground surface having been shot is computed based on an inclination and rotation angle of said video camera with respect to said airframe, and on an inclination and roll angle of said airframe with respect to the ground surface.

5. The video picture processing according to claim 1, wherein after obtaining a photographic range of the ground surface by computation, altitude of the ground surface in said photographic range. is obtained by utilizing a three-dimensionally topographic data including altitude information regarding ups and downs of the ground surface which data are preliminarily created, altitude of the photographic point is calculated as a relative altitude obtained by subtracting altitude of the ground surface from an absolute altitude of the airframe, and the video picture is transformed in conformity with the photographic range and displayed in such a manner as being superimposed on the map of the geographic information system.

6. The video picture processing method according to claim 1, wherein a video picture superimposed on the map can be erased with only the photographic frame being left.

7. The video picture processing method according to claim 1, wherein the video pictures can be displayed in a definite direction irrelative to direction of a video camera.

8. A video picture processing method intending to take a shot of a ground surface in succession from a video camera mounted on an airframe in the air and identify situations existing on the ground surface;
the method comprising the steps of: specifying three-dimensionally a photographic position in the air; computing each of a plurality of photographic ranges of the ground surface having been shot in succession; transforming each video picture in conformity with each of the photographic ranges; and displaying the plurality of video pictures in such a manner as being superimposed on a map of a geographic information system.

9. The video picture processing method according to claim 8, wherein a photographic range of the ground surface having been shot is computed based on an inclination and rotation angle of said video camera with respect to said airframe.

10. The video picture processing method according to claim 8, wherein a photographic range of the ground surface having been shot is computed based on an inclination and roll angle of said airframe with respect to the ground surface.

11. The video picture processing method according to claim 8, wherein a photographic range of the ground surface having been shot is computed based on an inclination and rotation angle of the mentioned video camera with respect to the mentioned airframe, and on an inclination and roll angle of the mentioned airframe with respect to the ground surface.

12. The video picture processing method according to claim 8, wherein a plurality of video pictures to be superimposed are joined so that a part of the video pictures may be overlapped with each other.

13. The video picture processing method according to claim 12, wherein video pictures, which are joined being overlapped, are moved and compensated so that an overlapped state in areas of overlap may be the greatest, and thereafter joined.

14. The video picture processing method according to claim 8, wherein a plurality of video pictures to be overlapped are obtained by sampling the video pictures having been shot continuously on cycles of a predetermined time.

15. The video picture processing method according to claim 14, wherein a sampling period can be changed.

16. The video picture processing according to claim 8, wherein after obtaining a photographic range of the ground surface by computation, altitude of the ground surface in said photographic range is obtained by utilizing a three-dimensionally topographic data including altitude information regarding ups and downs of the ground surface which data are preliminarily created, altitude of the photographic point is calculated as a relative altitude obtained by subtracting altitude of the ground surface from an absolute altitude of the airframe, and the video picture is transformed in conformity with the photographic range and displayed in such a manner as being superimposed on the map of the geographic information system.

17. The video picture processing method according to claim 8, wherein a video picture superimposed on the map can be erased with only the photographic frame being left.

18. The video picture processing method according to claim 8, wherein the video pictures can be displayed in a definite direction irrelative to direction of a video camera.

19. A video picture processing method intending to take a shot of a ground surface from a video camera mounted on an airframe in the air and identify situations existing on the ground surface;
the method comprising the steps of: specifying three-dimensionally a photographic position in the air; transmitting a video picture having been shot in sync with said airframe position information, camera information and airframe information; computing a photographic range of the ground surface having been shot on the receiving side; transforming a video picture is transformed in conformity with the photographic range; and displaying the transformed picture in such a manner as being superimposed on a map of a geographic information system.

20. The video picture processing method according to claim 19, wherein a video picture superimposed on the map can be erased with only the photographic frame being left.
